(19) United States
(12) Patent Application Publication
(10) Pub. No.: US 2003/0196688 A1
(43) Pub. Date: Oct. 23, 2003

(54) Car wash system having a sprayhead-mounting roller carried rotatably by a gantry

(76) Inventor: Hung-Ming Yang, Tai-Pao City (TW)

Correspondence Address: GRAY CARY WARE & FREIDENRICH LLP, 2000 UNIVERSITY AVENUE, E. PALO ALTO, CA, 94303-2248, US

(21) Appl. No.: 10/125,096

(22) Filed: Apr. 17, 2002

(51) Int. Cl. B60S 3/04

(52) U.S. Cl. 134/57 R; 134/123

(57) ABSTRACT

A car wash system includes a gantry mounted for movement relative to a vehicle during a car wash cycle. A sprayhead-mounting roller is mounted rotatably on the gantry. At least one sprayhead is mounted on the sprayhead-mounting roller. A bi-directional motor is coupled to the sprayhead-mounting roller for driving bi-directional rotation of the sprayhead-mounting roller. A programmable control circuit is connected electrically to the bi-directional motor and is operable so as to control the bi-directional motor to enable reciprocating movement of the sprayhead-mounting roller between forward and rearward spray limit positions during the car wash cycle.

### BACKGROUND OF THE INVENTION

1. Field of the Invention

The invention relates to a car wash system, more particularly to a car wash system having a sprayhead-mounting roller that is carried rotatably by a gantry.

2. Description of the Related Art

Car wash systems utilizing scrubbing strips to clean the bodies of cars may damage the painted surfaces of the cars. There are also available car wash systems that use rotary sprayheads to deliver jets of water for washing cars.

FIG. 1 shows a conventional car wash system that employs rotary sprayheads. As shown, the conventional car wash system includes a pair of spaced apart rails 1 mounted on a ground surface 10, and an inverted U-shaped gantry 2 mounted on the rails 1. The gantry 2 includes a pair of upright support members 21, a connecting member 22 interconnecting top ends of the support members 21, an overhead support 23 mounted below the connecting member 22 and driven by a motor (not shown) to move upwardly and downwardly relative to the connecting member 22, and a plurality of spraying devices 24 mounted on the support members 21 opposite to each other and on a bottom side of the overhead support 23. Each of the spraying devices 24 includes a plurality of sprayheads 241 for spraying high-pressure water. During a car wash cycle, a car 11 parked between the rails 1 remains stationary. The gantry 2 is motor-driven for movement along the rails 1 relative to the car 11. During movement of the gantry 2, the spraying devices 24 on the support members 21 deliver sprays of water to the lateral sides of the car 11, while the spraying devices 24 on the overhead support 23 sprays water onto the top side of the car 11. At the same time, the overhead support 23 is operable to move upwardly or downwardly so as to match the height of the car 11. As the top of the car 11 is generally curved, it is desirable that the overhead support 23 can bring the spraying devices 24 thereon to rotate so as to deliver sprays of water onto the top of the car 11 from suitable angles.

Although the aforesaid conventional car washing system can prevent scratching of the painted surface of the car 11 by the elimination of scrubbing strips, as the spraying devices 24 spray water onto the car 11 from relatively fixed positions, the cleaning effect is not satisfactory.

### SUMMARY OF THE INVENTION

Therefore, the main object of the present invention is to provide a car wash system that utilizes movable sprayheads to effectively and quickly clean a car. Accordingly, a car wash system according to the present invention includes:

a gantry mounted for movement relative to a vehicle during a car wash cycle;

a sprayhead-mounting roller mounted rotatably on the gantry;

at least one sprayhead mounted on the sprayhead-mounting roller;

a bi-directional motor coupled to the sprayhead-mounting roller for driving bi-directional rotation of the sprayhead-mounting roller; and

a programmable control circuit connected electrically to the bi-directional motor and operable so as to control the bi-directional motor to enable reciprocating movement of the sprayhead-mounting roller between forward and rearward spray limit positions during the car wash cycle.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic front view of a conventional car wash system in a state of washing a car;

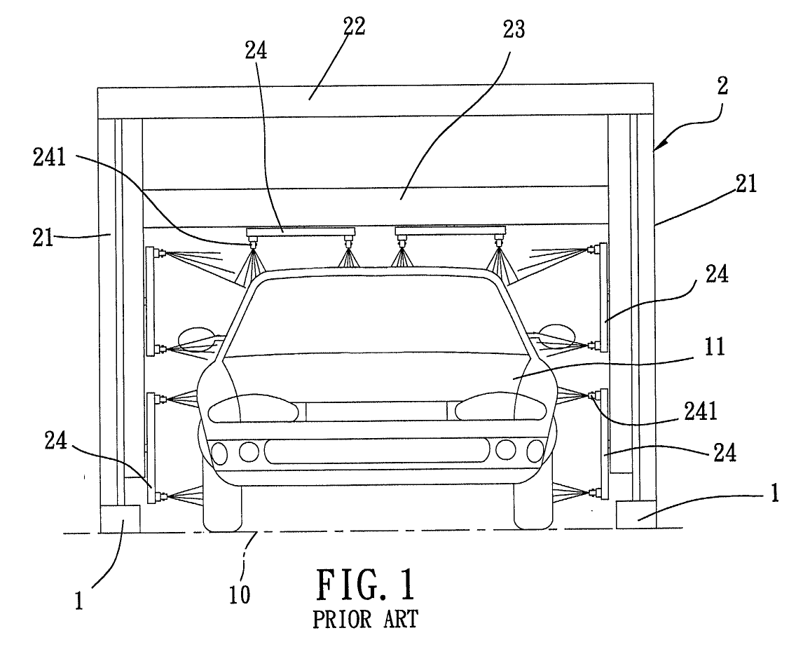

FIG. 2 is a schematic front view of a preferred embodiment of a car wash system according to the present invention;

FIG. 3 is a fragmentary perspective view of the preferred embodiment, illustrating a sprayhead-mounting roller and associated components of an oscillation control device; and

FIG. 4 is a circuit diagram of the oscillation control device according to the preferred embodiment.

### DETAILED DESCRIPTION OF THE PREFERRED EMBODIMENT

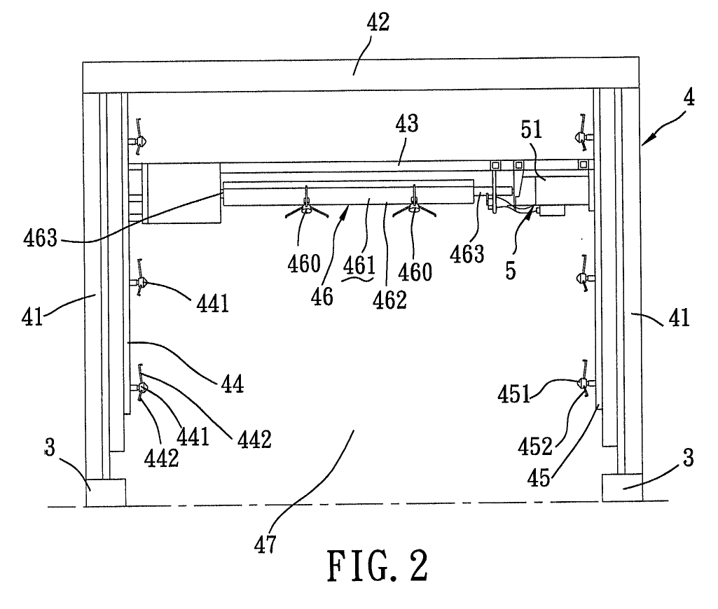

Referring to FIG. 2, the preferred embodiment of a car wash system according to the present invention is shown to include two spaced-apart parallel rails 3 disposed on a ground surface, a gantry 4 mounted for reciprocating movement on the rails 3 relative to a vehicle (not shown) disposed between the rails 3 during a car wash cycle, and an oscillation control device 5.

The gantry 4 includes a pair of upright support members 41 mounted movably on the rails 3 for synchronous reciprocating movement therealong, a connecting member 42 disposed between and interconnecting upper ends of the support members 41, and a horizontal overhead support 43 mounted below the connecting member 42 and driven by a motor (not shown) to move upwardly and downwardly relative to the connecting member 42. The support members 41 and the overhead support 43 cooperate to define a washing space 47 for passage of the vehicle (not shown). Spraying devices 44, 45, 46 are respectively mounted on the support members 41 and the overhead support 43, are oriented toward the washing space 47, and are operable to simultaneously spray-wash the vehicle (not shown) passing through the washing space 47. In this embodiment, each of the spraying devices 44, 45 that are mounted on the support members 41 has a plurality of hydroactuatble rotary sprayheads 441, 451 mounted rotatably thereon. Each of the sprayheads 441, 451 has a plurality of nozzles 442, 452 and is operable to spin and eject circular sprays. For the sake of brevity, a detailed description of the construction of the spraying devices 44, 45 and the sprayheads 441, 451, which are known in the art, is dispensed with herein.

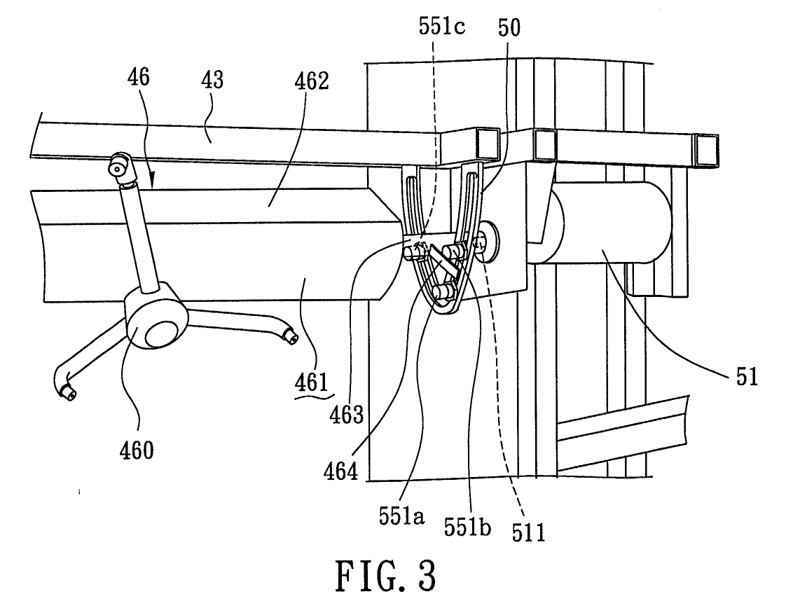

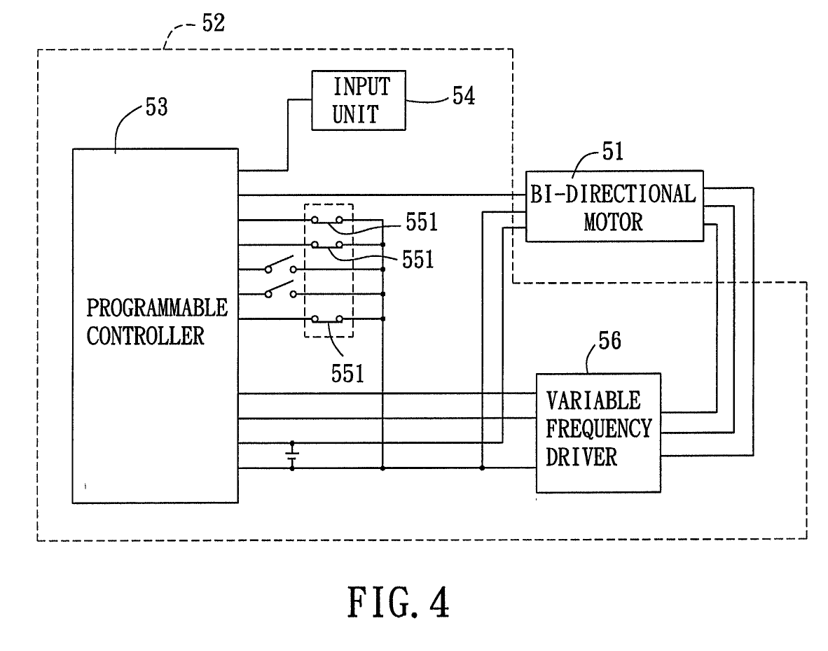

Referring further to FIG. 3, the spraying device 46, which is mounted on the overhead support 43, is different from conventional spraying devices in that the spraying device 46 includes a sprayhead-mounting roller 461 mounted rotatably on and in parallel to the overhead support 43 of the gantry 4. A plurality of sprayheads 460, which are similar to the aforesaid sprayheads 441, 451 in construction, are mounted on the sprayhead-mounting roller 461. The sprayhead roller 461 includes a roller body 462, two pivot shafts 463 projecting coaxially and respectively from two opposite ends of the roller body 462, and a sensor strip 464, which projects radially outward from one of the pivot shafts 463. The angle of rotation of the roller body 462 can be determined by observing the angle of rotation of the sensor strip 464. With further reference to FIG. 4, the oscillation control device 5 includes a bi-directional motor 51 and a programmable control circuit 52. The bi-directional motor 51 is mounted on a bottom portion of the overhead support 43 and is coupled to the roller body 462 of the sprayhead-mounting roller 461 for driving bi-directional rotation of the roller body 462 of the sprayhead-mounting roller 461. In this embodiment, the bi-directional motor 51 has a spindle 511 mounted coaxially and integrally with the pivot shaft 463 that is provided with the sensor strip 464.

The programmable control circuit 52 is connected electrically to the bi-directional motor 51 and is operable so as to control the bi-directional motor 51 to enable reciprocating movement of the roller body 462 of the sprayhead-mounting roller 461 between forward and rearward spray limit positions during the car wash cycle. The programmable control circuit 52 includes a programmable controller 53, an input unit 54, a plurality of sensing units 551, and a variable frequency driver 56. Except for the sensing units 551, which need to be mounted at specific positions (to be described hereinafter), the rest of the components of the programmable control circuit 52 can be disposed on the gantry 4 at suitable positions depending on the available space and actual requirements. For instance, in this embodiment, the programmable control circuit 52 is mounted within the overhead support 43 (not visible in FIGS. 2 and 3).

The operation of the programmable controller 53 is configured by programming, and relevant control data can be inputted beforehand via the input unit 54. The programmable controller 53 can be used to set the angle of rotation of the spindle 511 of the bi-directional motor 51 during the car wash cycle, and can control the spindle 511 to rotate bi-directionally about small angles to thereby enable the sprayheads 460 on the sprayhead-mounting roller 461 to deliver sprays of water from suitable angles, which will be described in the succeeding paragraphs.

The input unit 54 in this embodiment is configured as a touch-control type panel having a plurality of keys, and is connected to the programmable controller 53 via a conventional input interface. As such configuration belongs to known circuit design, for the sake of brevity, it is not depicted in detail in the drawings nor exemplified further herein.

The sensing units 551 can be known proximity switches but are not limited thereto. In this embodiment, there are three sensing units 551 connected electrically to the programmable controller 53. A substantially semi-circular curved mounting plate 50 is mounted on the bottom portion of the overhead support 43 of the gantry 4 to surround the pivot shaft 463 of the roller body 462 that is provided with the sensor strip 464. The sensing units 551 are mounted on the mounting plate 50 and are angularly spaced apart from each other so as to be disposed around the pivot shaft 463 with the sensor strip 464. When the sensor strip 464 rotates with the roller body 462 of the sprayhead-mounting roller 461, each of the sensing units 551 will provide a position signal to the programmable controller 53 in a known manner upon detection that the sensor strip 464 is disposed in close proximity thereto. Thus, the programmable controller 53 can detect the angles of rotation of both the spindle 511 of the bi-directional motor 51 and the sprayhead-mounting roller 461 to thereby control rotation of the bi-directional motor 51. The sensing units 551 in this embodiment are, respectively, an initial position sensor 551a mounted at a first position corresponding to an initial position of the sprayhead-mounting roller 461, a forward limit sensor 551b mounted at a second position corresponding to the forward spray limit position of the sprayhead-mounting roller 461, and a rearward limit sensor 551c mounted at a third position corresponding to the rearward spray limit position of the sprayhead-mounting roller 461. That is, upon activation or deactivation of the car wash system, the spindle 511 of the bi-directional motor 51 is caused to rotate to a position such that the sensor strip 464 is in close proximity to the initial position sensor 551a. The forward and rearward limit sensors 551b, 551c, which are disposed on either side of the initial position sensor 551a, are disposed to limit the angular range of rotation of the spindle 511 of the bi-directional motor 51 and hence the angular range of rotation of the sensor strip 464 such that the angular range of the sensor strip 464 is confined between the forward and rearward limit sensors 551b, 551c. In actual practice, the control of the angle of rotation of the sprayhead-mounting roller 461 and the spindle 511 of the bi-directional motor 51 is not limited to the aforesaid arrangement. For instance, the sensing units 551 can be encoders (also known as position detectors) mounted adjacent to the spindle 511 of the bi-directional motor 51 to detect the angle of rotation of the spindle 511 and to send position signals to the programmable controller 53.

The variable frequency driver 56 is connected electrically to the programmable controller 53 and the bi-directional motor 51. The programmable controller 53 controls the variable frequency driver 56 in accordance with the position signals from the sensing units 551 so as to drive the bi-directional motor 51 to rotate the sprayhead-mounting roller 461 at different speeds between the forward and rearward spray limit positions during the car wash cycle.

It is noted that the programmable controller 53 can be configured to control the bi-directional motor 51 to drive the sprayhead-mounting roller 461 to operate in different modes according to different mode settings. For instance, during a rearward stroke, the sprayhead-mounting roller 461 can be set to rotate 1-degree rearward and then 0.8-degree forward in a cyclical manner, thereby permitting the sprayheads 460 on the sprayhead-mounting roller 461 to oscillate while spin-spraying. Alternatively, the sprayhead-mounting roller 461 can be set to rotate rearward by predetermined step angles (of 3 degrees, for instance) and to dwell thereat for a suitable period of time. During each dwell, the sprayhead-mounting roller 461 can be set to reciprocate about a small angle (of 1 degree, for instance) very quickly, thereby achieving a satisfactory cleaning effect.

In the present invention, during any of the operational modes, the spraying device 46 is operable to spin and oscillate while delivering sprays of high-pressure water from different angles to quickly wash away dust and dirt on the surface of a vehicle. While the present invention is exemplified using the spraying device 46 that is mounted below the overhead support 43, it should be apparent to one skilled in the art that the spraying devices 44, 45 mounted on the support members 41 can also be configured to have the same oscillatory spin-spraying function so as to deliver sprays of water to lateral sides of the vehicle. While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A car wash system comprising:
a gantry mounted for movement relative to a vehicle during a car wash cycle;
a sprayhead-mounting roller mounted rotatably on said gantry;
at least one sprayhead mounted on said sprayhead-mounting roller;
a bi-directional motor coupled to said sprayhead-mounting roller for driving bi-directional rotation of said sprayhead-mounting roller; and
a programmable control circuit connected electrically to said bi-directional motor and operable so as to control said bi-directional motor to enable reciprocating movement of said sprayhead-mounting roller between forward and rearward spray limit positions during the car wash cycle.

2. The car wash system as claimed in claim 1, wherein said sprayhead-mounting roller has one end provided with a sensor strip, said programmable control circuit including a programmable controller and a plurality of sensing units connected electrically to said programmable controller, said sensing units being mounted on said gantry such that said sensing units are angularly spaced apart from each other and are disposed around said one end of said sprayhead-mounting roller, each of said sensing units providing a position signal to said programmable controller upon detection that said sensor strip is disposed in close proximity thereto.

3. The car wash system as claimed in claim 2, wherein said sensing units include an initial position sensor mounted at a first position corresponding to an initial position of said sprayhead-mounting roller, a forward limit sensor mounted at a second position corresponding to the forward spray limit position of said sprayhead-mounting roller, and a rearward limit sensor mounted at a third position corresponding to the rearward spray limit position of said sprayhead-mounting roller.

4. The car wash system as claimed in claim 2, wherein said programmable control circuit further includes a variable frequency driver connected electrically to said programmable controller and said bi-directional motor, said programmable controller controlling said variable frequency driver in accordance with the position signals from said sensing units so as to drive said bi-directional motor to rotate said sprayhead-mounting roller at different speeds between the forward and rearward spray limit positions during the car wash cycle.
